(19) United States
(12) Patent Application Publication
(10) Pub. No.: US 2023/0284072 A1
(43) Pub. Date: Sep. 7, 2023

(54) User Level Mobility Load Balancing

(71) Applicant: Parallel Wireless, Inc., Nashua, NH (US)

(72) Inventors: David Khemelevsky, Kfar Sava (IL); Anoop Kumar, Pune (IN); Gayatri Bhoi, Puna (IN); Bipin Lakhera, Pune (IN); Gal Barak, Kfar Save (IL)

(21) Appl. No.: 18/152,149

(22) Filed: Jan. 9, 2023

Related U.S. Application Data
(60) Provisional application No. 63/297,282, filed on Jan. 7, 2022.

(51) Int. Cl. H04W 28/02; H04W 28/08

(52) U.S. Cl. CPC H04W 28/0226; H04W 28/0958; H04W 84/18

(57) ABSTRACT

A method of providing user level mobility load balancing is provided, the method comprising: classifying a group of User Equipments (UEs) in a cell into multidimensional planes based on metrics associated with the UEs; defining thresholds for each dimension; using the defined thresholds determining to discard or select certain planes of a dimension and the UEs contained in the planes; and identifying a best UE of the UEs contained in selected planes for offload.

### CROSS-REFERENCE TO RELATED APPLICATIONS

The present application claims priority under 35 U.S.C. § 119(e) to U.S. Provisional Patent Application No. 63/297,282, having the same title as the present application and filed Jan. 7, 2022, which is hereby incorporated by reference in its entirety for all purposes. The present application also hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

A self-organizing network (SON) is an automation technology designed to make the planning, configuration, management, optimization and healing of mobile radio access networks simpler and faster. SON functionality and behavior has been defined and specified in generally accepted mobile industry recommendations produced by organizations such as 3GPP (3rd Generation Partnership Project) and the NGMN (Next Generation Mobile Networks).

SON has been codified within 3GPP Release 8 and subsequent specifications in a series of standards including 36.902, as well as public white papers outlining use cases from the NGMN. The first technology making use of SON features will be Long Term Evolution (LTE), but the technology has also been retro-fitted to older radio access technologies such as Universal Mobile Telecommunications System (UMTS). The LTE specification inherently supports SON features like Automatic Neighbor Relation (ANR) detection, which is the 3GPP LTE Rel. 8 flagship feature.

### SUMMARY

As part of SON (self-organizing-networks) features, MLB (Mobility Load Balancing), introduced in 3GPP TS 32.860, hereby incorporated by reference, provides capabilities to optimize network capacity. Traditional approach mainly aims to optimize the resource utilization with control on cell level parameters. Our invention enhances the Traffic-Steering use case as part of ORAN use cases by employing UE level information to make more accurate decisions. The goal of both is to reach maximal resource utilization across multiple cells/Nodes with minimal to no compromise on end user experience.

Considering high level architecture the feature includes 3 main steps. Data level, what information is collected (e.g. load metric, UE measurements, . . . ), from whom its collected (granularity level UE/cell/Node), and how frequently is it collected. Algorithm level. the core of the logic itself, it needs to be robust to handle various use cases and various scenarios. Provisioning (decision implementation), what accuracy level is aimed while making the changes at UE, Cell, Node etc.

This invention provides load balancing among access nodes of a wireless network by re-distributing the user equipments (UEs) connected to them. It does this by calculating certain metrics for each of these nodes and then using these metrics in a load balancing algorithm that moves the UEs from one access node to another guided by a heuristic decision derived from the load balancing algorithm.

In one embodiment, a method of providing user level mobility load balancing includes classifying a group of User Equipments (UEs) in a cell into multidimensional planes based on metrics associated with the UEs; defining thresholds for each dimension; using the defined thresholds determining to discard or select certain planes of a dimension and the UEs contained in the planes; and identifying a best UE of the UEs contained in selected planes for offload.

### BRIEF DESCRIPTION OF THE DRAWINGS

FIG. 1 is a schematic diagram of UE load balancing as known in the prior art.

FIG. 2 is a schematic diagram showing cell space selection with multiple dimensions of UE characteristics, in accordance with some embodiments.

FIG. 3 is a schematic diagram of UE load balancing, in accordance with some embodiments.

FIG. 4A is a schematic flow diagram of UE load balancing, in accordance with some embodiments.

FIG. 4B is a schematic diagram of UE load balancing in N-dimensional space, in accordance with some embodiments.

FIG. 5 is a flow diagram of UE load balancing, in accordance with some embodiments.

FIG. 6 is a multiple radio access technology (RAT) core network diagram, in accordance with some embodiments.

FIG. 7 is an enhanced base station, in accordance with some embodiments.

FIG. 8 is a coordinating node for providing certain functions, in accordance with some embodiments.

### DETAILED DESCRIPTION

In general, the problem is that natively UE aims to camp on best serving cell. This is normally measured by best signal received by UE (RSRP [dBm]). The main challenge in addressing this problem is that—when we make changes on cell level for offloading traffic, there is no control if some of the UEs may find degraded user experience as a result of this change. In addition, there is no actual capability to indicate how many of the UEs will get offloaded and to which target. Hence even if the algorithm and data collection does include cell load at UE level, the challenge remains to find a method which is capable of controlling the provisioning at a per UE level.

The presently described methods and system provide a solution to this standard problem faced by telecom networks.

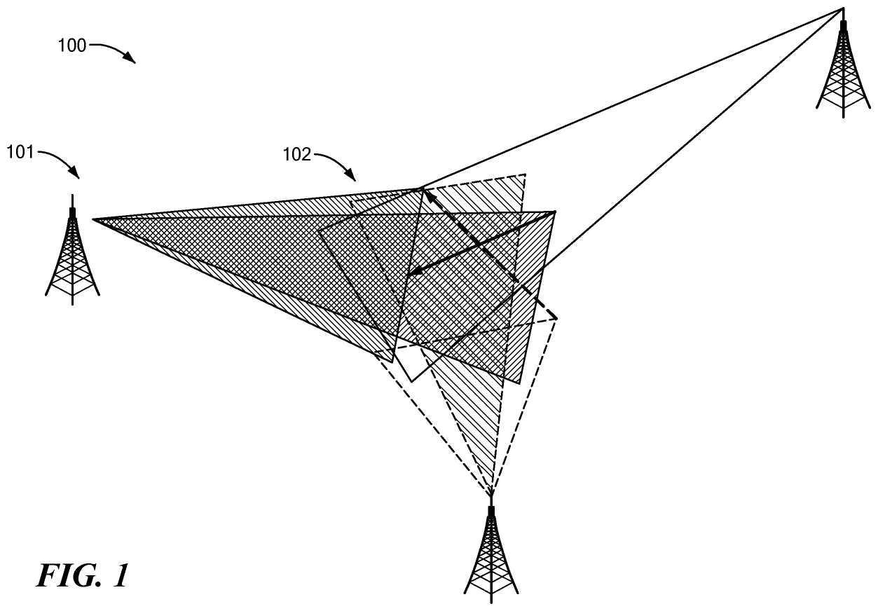

FIG. 1 shows UE load balancing, as known in the art. Cells 101 having coverage area 102 are performing offload, but using only cell-level offsets. This figure illustrates the challenge when working with cell level offsets to perform MLB. This eventually translates into issues like, UEs in emergency call, VoLTE, CA state, or in fast moving state are pushed to surrounding cells without any prioritization or an ability to control this. Such an attempt should be avoided in first place.

The cardinal aspect of the solution is that the orchestration is being done at per UE level. The implementation is done by HO (handover). Traditionally the HO is initiated for a UE mobility when a better cell is detected. In case of MLB the HO is initiated to optimize the network resources.

The solution has a concept of multiple dimensions per UE. The group of UEs in a cell are classified into multi-dimensional planes based on various metrics associated with them such as GBR/N-GBR; emergency/normal; speed of movement; relative neighbor power; and load on prospective target cells.

Each metric above represents a dimension of data provided to the algorithm. Different values of a metric represent different planes in that dimension.

Multi-Dimensional Algorithm

The load balancing algorithm defines thresholds for each dimension. It acts on each dimension simultaneously and uses dimension specific thresholds to—discard certain planes of a dimension (and UEs contained in them); or to select certain planes of a dimension (and UEs contained in them).

Out of the identified volume of N-dimensional space of a cell being load balanced (including the UEs contained in the space) the algorithm bubbles up the best UE for offload OUT of current cell. The offload could be via a handover to a target cell, or via redirection of UE to air or to another RAT (release). When the algorithm converges the output is a tuple of a UE and a target cell.

User Experience Preservation Effort

By default, the cost function of MLB distributes the traffic across multiple cells thereby compromising on the best serving cell selection for a UE. This can potentially lead to user experience degradation.

In order to minimize or to avoid this situation at together, the UE bubbling algorithm ensures that UE should experience least amount of degradation to the RF link to its serving cell. The user experience is retained or minimally impacted by considering the following UE characteristics during UE selection, such as, speed of its motion and services active on the UE. Additionally, other methods are also employed such as preventing repeated selection of a UE by prioritizing non-active UEs first and deprioritizing the UEs which might have failed in a previous offload attempt. This helps minimize the probability of drops and increases the MPD (min per drop).

Selectivity in Algorithm

The algorithm is precise enough to select the best offload UE immaterial of their physical distance from cell center or their proximity to cell edge. The algorithm exhibits this unique property because it selects UEs optimized from a space carved out of multi-dimensional UE characteristics and lets the best (optimized) UE bubble UP to be selected.

Scalability

The dimensions discussed in sections above are illustrative. The algorithm is flexible enough to add additional dimensions besides the ones described in previous sections.

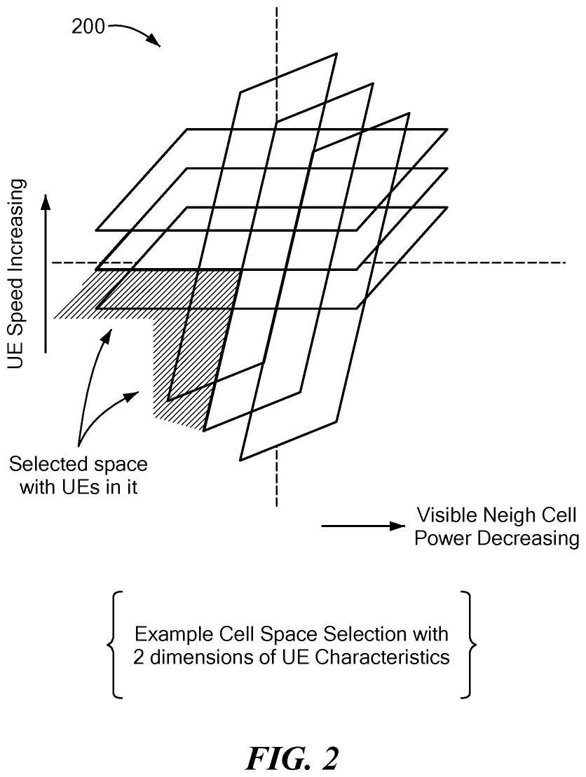

FIG. 2 shows the use of multimensional analysis in accordance with some embodiments. Cell space sepection with two dimensions of UE characteristics is shown. Here the dimensions are UE speed (as measured from a particular cell tower) and visible neighbor cell power. There are no solutions selected where cell power is decreasing (positive x direction) and UE speed is increasing (positive y direction), and instead solutions are selected by separating the solution space into dimensions and selecting those solutions that select towers where UEs behave in a decreasing speed direction and an increasing cell power direction. By selecting along these two dimensions, a user experience maximizing result is achieved. Different dimensions can be considered, and as well, multiple dimensions can be considered at the same time. A maximizing algorithm may find solutions that maximize all selected dimensions, in some embodiments, or in the case that this is not possible or where no clearly desirable solution may be present, the dimensions may be ordered in order of priority (this could be considered an additional dimension) such that user experience is maximized, in some embodiments.

In some embodiments, data may be used that takes into account additional information over time, such as direction of travel, increase or decrease in signal power, etc. In some embodiments UE characteristics such as RAT support, data rate support, observed signal to noise (SNR) or related parameters may be considered.

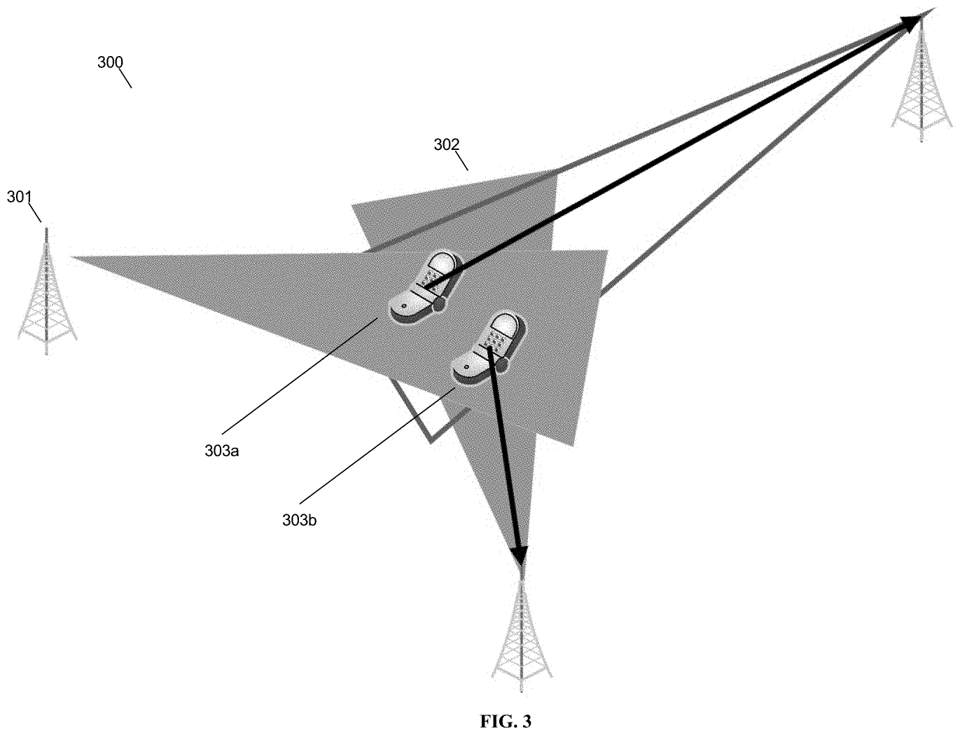

FIG. 3 shows UE load balancing based on a multidimensional load balancing analysis, in accordance with some embodiments. The UEs are being balanced taking into direction their direction of travel as well as their

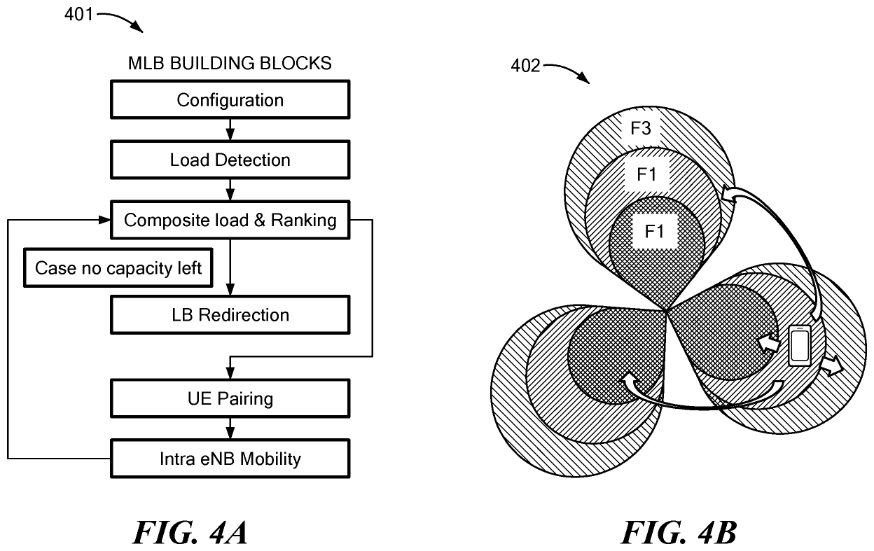

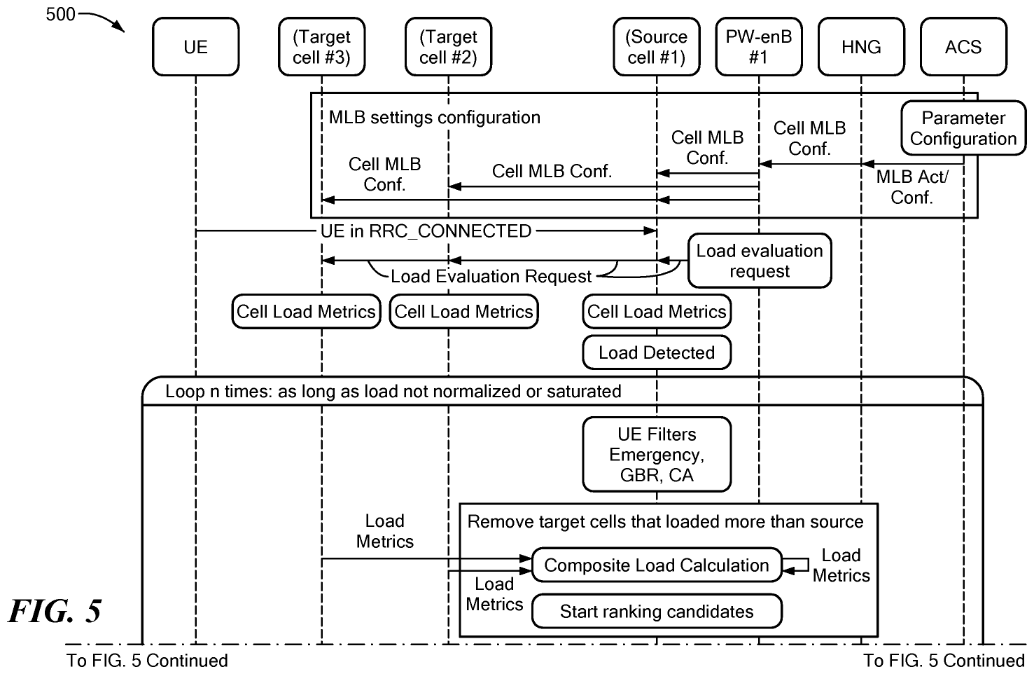

FIG. 4A shows a sequence for use in a load balancing algorithm, in some embodiments. Configuration is the first stage. The second stage is load detection. The third stage is composite load and ranking. The fourth stage may be either LB redirection, in the case that no capacity is left, or, UE pairing, in the case that some capacity is available. The fifth stage is intra eNB mobility, initiated by the UE, in some embodiments, which once reaching a significance threshold causes the system to return to the third stage, composite load and ranking. The ranking is performed in accordance with the multidimensional analysis described hereinabove, in some embodiments.

FIG. 4B shows a UE being considered for load balancing, in accordance with some embodiments. Three co-located cells, which may have different carrier frequencies or different RATs and thus different coverage areas, F1, F2, F3 are shown, each with three lobes, typical with a 3-sector cell coverage pattern. A UE in F2 is considered for load balancing between different sectors, or between the different cells.

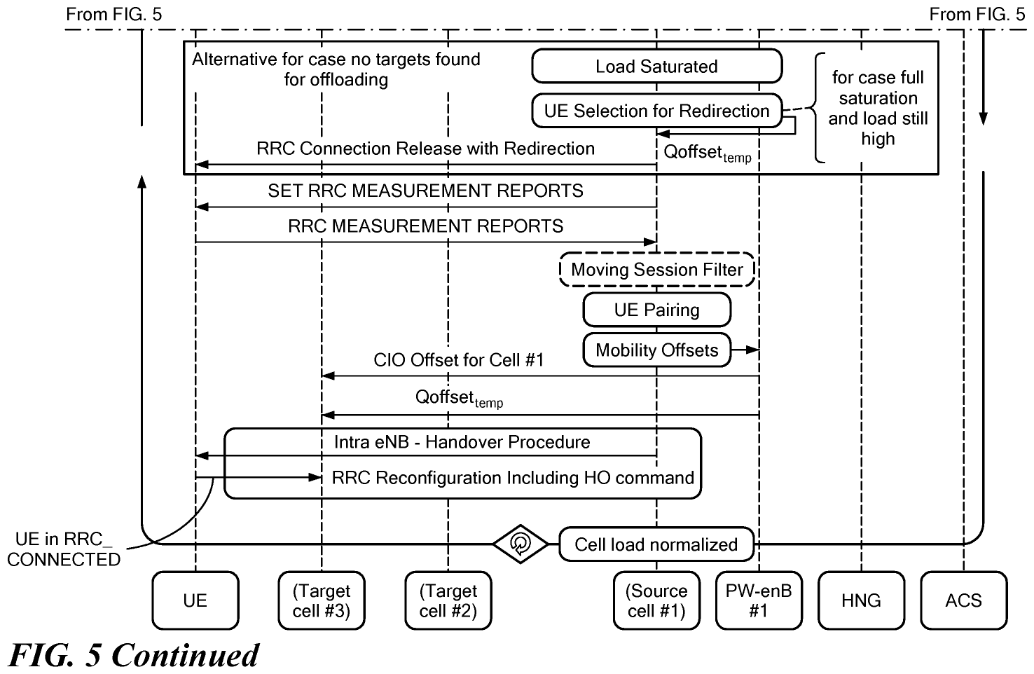

FIG. 5 shows a sequence diagram for load balancing, in accordance with some embodiments. Config server ACS is used for load balancing settings configuration with all cells; a loop is performed as long as load is not normal or saturated to perform load balancing; target cells are removed in some embodiments.

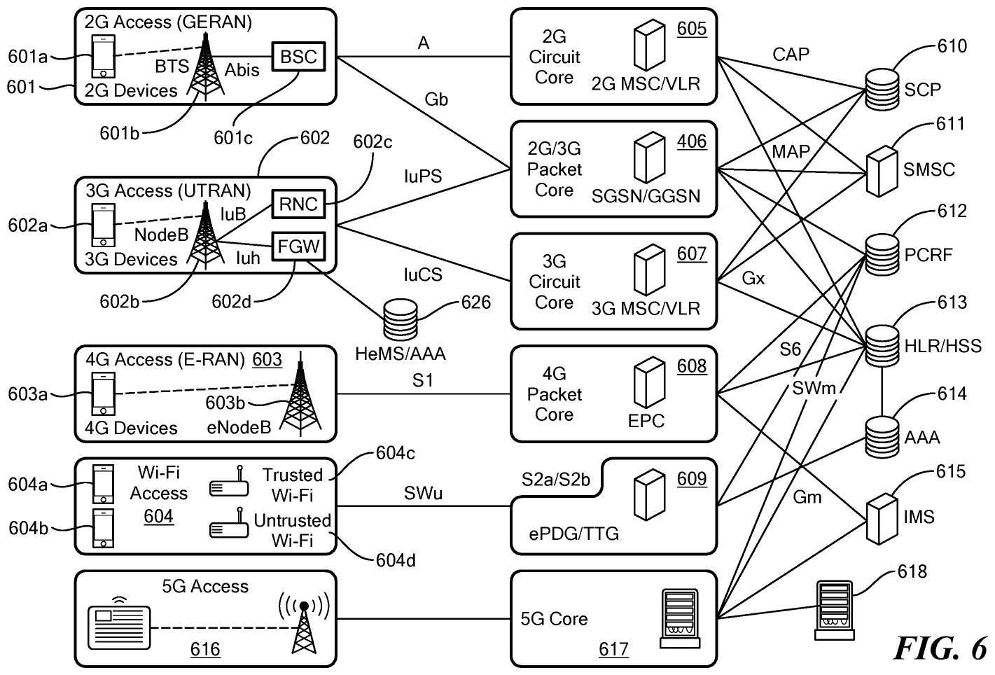

FIG. 6 is a schematic network architecture diagram for 3G and other-G prior art networks. The diagram shows a plurality of “Gs,” including 2G, 3G, 4G, 5G and Wi-Fi. 2G is represented by GERAN 601, which includes a 2G device 601a, BTS 601b, and BSC 601c. 3G is represented by UTRAN 602, which includes a 3G UE 602a, nodeB 602b, RNC 602c, and femto gateway (FGW, which in 3GPP namespace is also known as a Home nodeB Gateway or HNBGW) 602d. 4G is represented by EUTRAN or E-RAN 603, which includes an LTE UE 603a and LTE eNodeB 603b. Wi-Fi is represented by Wi-Fi access network 604, which includes a trusted Wi-Fi access point 604c and an untrusted Wi-Fi access point 604d. The Wi-Fi devices 604a and 604b may access either AP 604c or 604d. In the current network architecture, each “G” has a core network. 2G circuit core network 605 includes a 2G MSC/VLR; 2G/3G packet core network 606 includes an SGSN/GGSN (for EDGE or UMTS packet traffic); 3G circuit core 607 includes a 3G MSC/VLR; 4G circuit core 608 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 630, the SMSC 631, PCRF 632, HLR/HSS 633, Authentication, Authorization, and Accounting server (AAA) 634, and IP Multimedia Subsystem (IMS) 635. An HeMS/AAA 636 is present in some cases for use by the 3G UTRAN. The diagram is used to indicate schematically the basic functions of each network as known to one of skill in the art, and is not intended to be exhaustive. For example, 5G core 617 is shown using a single interface to 5G access 616, although in some cases 5G access can be supported using dual connectivity or via a non-standalone deployment architecture.

Noteworthy is that the RANs 601, 602, 603, 604 and 636 rely on specialized core networks 605, 606, 607, 608, 609, 637 but share essential management databases 630, 631, 632, 633, 634, 635, 638. More specifically, for the 2G GERAN, a BSC 601c is required for Abis compatibility with BTS 601b, while for the 3G UTRAN, an RNC 602c is required for Iub compatibility and an FGW 602d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

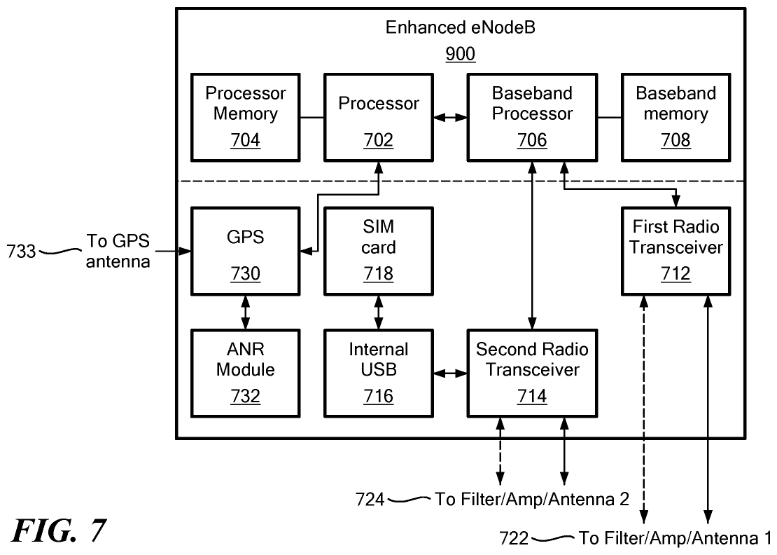

FIG. 7 is an enhanced eNodeB for performing the methods described herein, in accordance with some embodiments. While an eNodeB is shown, a gNB or other new radio base station is also intended to be covered by the present figure. eNodeB 700 may include processor 702, processor memory 704 in communication with the processor, baseband processor 706, and baseband processor memory 708 in communication with the baseband processor. Mesh network node 700 may also include first radio transceiver 712 and second radio transceiver 714, internal universal serial bus (USB) port 716, and subscriber information module card (SIM card) 718 coupled to USB port 716. In some embodiments, the second radio transceiver 714 itself may be coupled to USB port 716, and communications from the baseband processor may be passed through USB port 716. The second radio transceiver may be used for wirelessly backhauling eNodeB 700.

Processor 702 and baseband processor 706 are in communication with one another. Processor 702 may perform routing functions, and may determine if/when a switch in network configuration is needed. Baseband processor 706 may generate and receive radio signals for both radio transceivers 712 and 714, based on instructions from processor 702. In some embodiments, processors 702 and 706 may be on the same physical logic board. In other embodiments, they may be on separate logic boards.

Processor 702 may identify the appropriate network configuration, and may perform routing of packets from one network interface to another accordingly. Processor 702 may use memory 704, in particular to store a routing table to be used for routing packets. Baseband processor 706 may perform operations to generate the radio frequency signals for transmission or retransmission by both transceivers 710 and 712. Baseband processor 706 may also perform operations to decode signals received by transceivers 712 and 714. Baseband processor 706 may use memory 708 to perform these tasks.

The first radio transceiver 712 may be a radio transceiver capable of providing LTE eNodeB functionality, and may be capable of higher power and multi-channel OFDMA. The second radio transceiver 714 may be a radio transceiver capable of providing LTE UE functionality. Both transceivers 712 and 714 may be capable of receiving and transmitting on one or more LTE bands. In some embodiments, either or both of transceivers 712 and 714 may be capable of providing both LTE eNodeB and LTE UE functionality. Transceiver 712 may be coupled to processor 702 via a Peripheral Component Interconnect-Express (PCI-E) bus, and/or via a daughtercard. As transceiver 714 is for providing LTE UE functionality, in effect emulating a user equipment, it may be connected via the same or different PCI-E bus, or by a USB bus, and may also be coupled to SIM card 718. First transceiver 712 may be coupled to first radio frequency (RF) chain (filter, amplifier, antenna) 722, and second transceiver 714 may be coupled to second RF chain (filter, amplifier, antenna) 724.

SIM card 718 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 700 is not an ordinary UE but instead is a special UE for providing backhaul to device 700.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 712 and 714, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 702 for reconfiguration.

A GPS module 730 may also be included, and may be in communication with a GPS antenna 732 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 732 may also be present and may run on processor 702 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

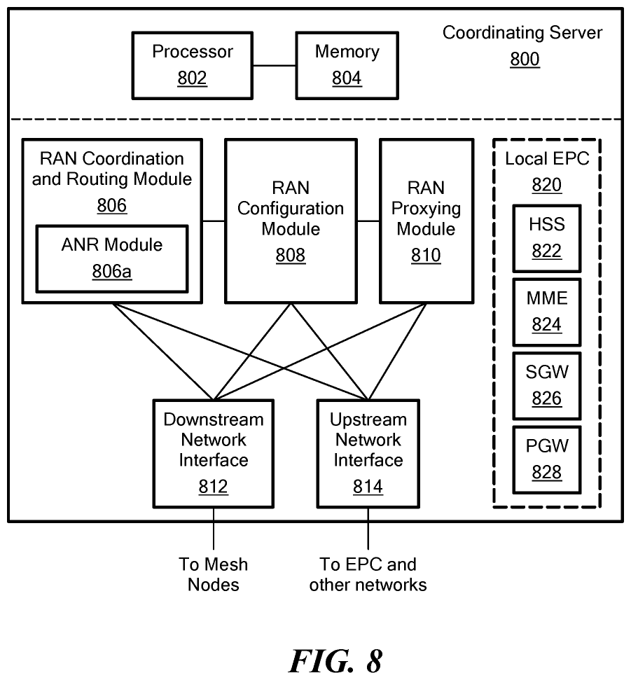

FIG. 8 is a coordinating server for providing services and performing methods as described herein, in accordance with some embodiments. Coordinating server 800 includes processor 802 and memory 804, which are configured to provide the functions described herein. Also present are radio access network coordination/routing (RAN Coordination and routing) module 806, including ANR module 806a, RAN configuration module 808, and RAN proxying module 810. The ANR module 806a may perform the ANR tracking, PCI disambiguation, ECGI requesting, and GPS coalescing and tracking as described herein, in coordination with RAN coordination module 806 (e.g., for requesting ECGIs, etc.). In some embodiments, coordinating server 800 may coordinate multiple RANs using coordination module 806. In some embodiments, coordination server may also provide proxying, routing virtualization and RAN virtualization, via modules 810 and 808. In some embodiments, a downstream network interface 812 is provided for interfacing with the RANs, which may be a radio interface (e.g., LTE), and an upstream network interface 814 is provided for interfacing with the core network, which may be either a radio interface (e.g., LTE) or a wired interface (e.g., Ethernet).

Coordinator 800 includes local evolved packet core (EPC) module 820, for authenticating users, storing and caching priority profile information, and performing other EPC-dependent functions when no backhaul link is available. Local EPC 820 may include local HSS 822, local MME 824, local SGW 826, and local PGW 828, as well as other modules. Local EPC 820 may incorporate these modules as software modules, processes, or containers. Local EPC 820 may alternatively incorporate these modules as a small number of monolithic software processes. Modules 806, 808, 810 and local EPC 820 may each run on processor 802 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of providing user level mobility load balancing, the method comprising:
classifying a group of User Equipments (UEs) in a cell into multidimensional planes based on metrics associated with the UEs;
defining thresholds for each dimension;
using the defined thresholds determining to discard or select certain planes of a dimension and the UEs contained in the planes; and
identifying a best UE of the UEs contained in selected planes for offload.
